(19) United States
(12) Patent Application Publication
(10) Pub. No.: US 2007/0180638 A1
(43) Pub. Date: Aug. 9, 2007

(54) Self-cleaning hair brush with replaceable preloaded bristle mat

(76) Inventor: William D. McKay, Grand Blanc, MI (US)

Correspondence Address: GOTTLIEB RACKMAN & REISMAN PC, 270 MADISON AVENUE, 8TH FLOOR, NEW YORK, NY, 100160601, US

(21) Appl. No.: 11/702,902

(22) Filed: Feb. 6, 2007

Related U.S. Application Data
(63) Continuation of application No. 11/480,149, filed on Jun. 30, 2006.
(60) Provisional application No. 60/774,054, filed on Feb. 16, 2006.
(60) Provisional application No. 60/771,142, filed on Feb. 7, 2006.

(51) Int. Cl. A46B 13/00

(52) U.S. Cl. 15/22.1; 15/114

(57) ABSTRACT

A brush for hygienic purposes includes a handle with a lower and an upper portion and a head. The upper portion is sized and shaped to capture the head. Preferably the head is a removable cartridge and includes a flexible base with a plurality bristles and a pad with holes disposed over the bristles. The pad could be a foam or sponge matrix or could be a stack of sheets removable one at a time. Upper portion of the handle is curved to provide a predetermined shape to the head. Optionally, a vibrating device is incorporated in the brush so that the brush can be used as to massage the skin or scalp.

RELATED APPLICATIONS

This application claims priority to U.S. Provisional Application Ser. No. 60/774,054 filed Feb. 16, 2006 and is a continuation-in-part of copending application Ser. No. 11/480,149 entitled A SELF-CLEANING BRUSH WITH A FLEXIBLE MATRIX, filed on Jun. 30, 2006 and claiming priority to Provisional Application Ser. No. 60/771,142 filed Feb. 7, 2006, all incorporated herein by reference.

The subject matter of this application is also related to my co-pending application Ser. No. 10/930,419, filed Aug. 31, 2004 and entitled “Liquid Dispensing Brush,” which is a continuation-in-part of co-pending application Ser. No. 10/851,503 filed May 21, 2004 and entitled “Grooming/Cleaning Apparatus” which is a continuation-in-part of co-pending application Ser. No. 10/717,956, filed Nov. 20, 2003, and entitled “Grooming/Cleaning Apparatus”, which is a continuation-in-part of co-pending application Ser. No. 10/672,909 filed Sep. 26, 2003, and entitled “Lint Removal Apparatus with Edge Orientation”, which is a continuation-in-part of Ser. No. 10/812,475 which is a continuation-in-part of co-pending application Ser. No. 10/614,551, which is a continuation-in-part of co-pending application Ser. No. 10/329,717, which is a continuation-in-part of co-pending application Ser. No. 10/302,038, now U.S. Pat. No. 6,763,977, which is a continuation-in-part of co-pending application Ser. No. 10/143,396, now U.S. Pat. No. 6,698,626, the contents of each of which are incorporated herein by reference in their entirety.

### BACKGROUND OF THE INVENTION

A. Field of Invention

The invention is directed to a single-sided hair brush with a replaceable insert which contains bristles loaded with a plurality of wipes/cloths and/or a foam matrix that is preferably imbibed with hair care treatment chemicals.

B. Description of the Prior Art

Various hair care utensils have been devised for grooming, cleaning, treating, medicating, and otherwise taking care of human or pet hair, including utensils such as combs and brushes.

Other hair grooming utensils include various spraying devices including manual pump sprays, pressurized aerosol containers, etc. These utensils are employed for applying hair coloring, cleansing solutions, medicinal compositions to treat various ailments, etc.

Conventional brushes have a plurality of bristles arranged in various two-dimensional patterns. While brushes are effective for hair grooming, they cannot apply significant quantities of liquid or remove soils or other foreign materials. Conventional brushes are also less than desirable for applying medicinal or other treatment compositions to hair and scalp.

Moreover, while in use, brushes also collect loose hair, dandruff, skin flakes, as well as foreign matter stuck in the hair (especially a pet's hair), all of which get stuck between, or entangled around the bristles. All this matter is unsightly and unsanitary. Removing this matter is difficult and unappetizing. Frequently, people clean one brush by using on it another brush or a comb. However, this operation merely transfers the undesirable matter from one utensil to another, thereby compounding the problem. If the matter is not removed from a brush, its repeated usage renders it ineffective, and eventually the brush is discarded even though it could be perfectly useable if it was cleaned properly.

It is desirable therefore to provide a brush which is self cleaning. It is also desirable to have a brush that is capable of applying medicine, cleansing solutions and other treatment materials to the hair, the skin or scalp or to collect or remove soils or oils from hair and scalp as the brush is drawn through the hair.

U.S. Pat. No. 3,512,518 to Mishkin discloses a brush for collecting cellular or bacterial specimens.

U.S. Pat. No. 3,641,610 to Lewis discloses a sponge with a plurality of embedded synthetic filaments. The filaments protrude through the sponge.

U.S. Pat. No. 2,819,482 to Applegate discloses a tooth brush with a plurality of bristles surrounded by a resilient sponge body 14.

U.S. Patent Application Publication 2002/0018687 discloses a sun-screen lotion dispenser with a handle, a reservoir on one end, and a pad formed of a terry-covered sponge on the other. The lotion is pumped from the reservoir to the pad.

U.S. Pat. No. 5,240,339 discloses a body lotion applicator with a head formed of a large open-cell sponge surrounded by a soft small open-cell foam.

U.S. Pat. No. 6,021,542 discloses a brush with bristles and replaceable apertured cleaning sheets.

U.S. Pat. No. 6,006,395 discloses a brush with replaceable bristles and mounted on a base.

U.S. Pat. No. 5,904,150 discloses a perforated base for receiving bristles extending from one side of the base to another and a front member with apertures receiving the bristles.

U.S. Pat. No. 6,421,872 discloses a brush with replaceable bristles.

Japanese Publication 08228822A discloses a folding brush;

U.S. Pat. No. 5,327,611 discloses a hair brush with replaceable bristles.

U.S. Pat. No. 5,247,718 discloses another hair brush with replaceable bristles.

### SUMMARY OF THE INVENTION

Briefly, the present invention pertains to a single-sided brush with an interchangeable or replaceable bristles insert. The single-sided hair brush of this invention cleans, conditions, colors, medicates, shines and/or delivers hair treatment chemicals to the hair and/or absorbs liquid, soil or oils from the hair/fur of humans or animals. The bristle insert includes a bristle mat from which a plurality of bristles extend as well as one or more wipes or an absorbent foam or sponge type matrix pre-assembled with the mat and fixed thereon. The wipes or matrix contain a plurality of holes through which the bristles extend.

The bristle insert can snap or slide into a compartment defined at the brush head—there may be some type of lock provided to facilitate engagement to the brush head. The one or more wipes may include some type of medical, cosmetic, powder or cleaning fluid designed for suitable delivery to the human or animal for which the brush is being used.

The invention in one embodiment is directed to a brush with a handle and an integral head with a hinged frame. The frame captures or otherwise locks an interchangeable, replaceable insert. The insert contains bristles and a plurality of preloaded wipes on absorbent substrate, such as a foam or sponge that can be pre-loaded with liquid or powder or provided dry without treatment.

In another form, the invention is directed to a single-sided interchangeable, replaceable insert containing a plurality of bristles and plurality of wipes, or at least one layer of an absorbent substrate, such as a foam and/or compartment in the brush to support the insert.

Importantly, the inventive replaceable refill insert for a brush is flat when assembled and preferably curved/oblate when installed into the brush handle in order to assist retention of the wipes contained thereon. The inventive brush insert is advantageous as it is preloaded and easy to install into a brush handle.

Also, adhesive is sometimes required in order to adhere multiple cloths or wipes to the brush. A pull tab is integrally formed with the wipes/cloths.

Optionally, an opening is provided in the lower brush body for the pull tab.

In one embodiment of the invention, the replaceable insert mat has an oblate or lens-shaped cross section. Preferably, the insert mat is included to create friction between the aperture and the bristles and helps retain the plurality of wipes/cloths or foam matrix in the bristle insert.

Optionally, a plastic cover made of PVC, polyethylene or polypropylene is provided in order to keep the brush head clean, and to retain the moisture in the plurality of wipes/cloths in the foam sponge matrix.

The inventive brush is used for animal and human hair. Importantly, the wipes/cloths or sponge foam used in the invention cannot be greater than 2 inches thick and no less than 1/64 inch thick, inclusive of all layers. The handle of the inventive brush is made from polyethylene, polypropylene, wood, styrene, elastomeric materials, or any combination thereof. The bristles may be formed in an elastomeric mat. The bristles themselves are made from polypropylene or polyethylene and are individually inserted into pre-punched holes in the mat or formed integrally with the mat. The mat is polypropylene or is made from polyethylene or any elastomeric rubberlike material.

The inventive brush design improves over prior art designs, in part, because of its ability for single-sided use, and therefore, more controlled application. Most importantly, the inventive brush includes a replaceable refill insert containing bristles and a plurality of wipes/cloths, wipe/cloth matrixes or a foam matrix. In other words, in one aspect of the invention, the present design improves over the prior art because it includes a replaceable, preloaded refill insert.

Once the interchangeable, replaceable insert is installed in the brush support section, it should preferably be oblate in cross section with the bristles forming an approximate 90° angle to an oblate mat in order to assist in keeping the wipes, cloths or sponge secured in position and thereby preventing them from falling off when the device is not in use. In that regard, the 90° angular position of the bristles, and the friction created by apertures in the wipe/cloth helps to keep the plurality of wipes/cloths in place. This holding action may be assisted by the pinching effect created by the upper and lower body parts within the support section of the brush, which can be assisted by a spring like insert contained within the structure/assembly.

In accordance with the invention, the bristle mat may be fixed in the head of the brush (not replaceable). A cleaning substrate, such as a plurality of wipes, a foam/sponge matrix or a pillow or cushion comprising a lamination (matrix) of layers containing powder or hot melt strips with any hair treatment, chemistry and/or powder composition optionally activated by water may be selectively placed over the bristle mat, prior to using the brush.

In one embodiment of the invention, the brush is provided with a vibrating device so that the brush could be used to massage the scalp and or the skin and to facilitate greater utility of the wipe/cloth or foam matrix.

### BRIEF DESCRIPTION OF THE DRAWINGS

FIG. 1 is a top plan view of a first embodiment of the inventive brush in an assembled condition;

FIG. 2 is a side elevational view of the brush of FIG. 1 in an assembled condition;

FIG. 3 is a bottom plan view of the brush of FIG. 1 in an open condition;

FIG. 4 is a front or end elevational view of the brush of FIG. 3;

FIG. 5 is a side exploded elevational view of the brush of FIG. 1 showing the cross-support member in an extended condition and the underlying bristle mat and plurality of wipes prior to mounting on the brush head;

FIG. 6 is a top plan view of an optional flexible rubber/flexomeric bristle mat to be used in the brush of FIG. 1 with a plurality of brushes or bristles extending from apertures formed in the mat;

FIG. 7 is an elevational view of one of the bristles that extend from the bristle mat in FIG. 6;

FIG. 8 is a bottom plan view of the bristle mat with integral bristles shown as white dots within the plastic rib webbing;

FIG. 9 is a top plan view of one of the plurality of wipes suitable for pre-assembly with the bristle mat of FIG. 5 with a pull tab along one side thereof;

FIG. 10 is a side elevational view of an alternative version of the brush shown in FIG. 1 in an assembled condition;

FIG. 11 is an exploded side view of the brush shown in FIG. 10;

FIG. 12 is an exploded front elevational view of a second embodiment of the inventive brush showing a pre-loading cartridge comprising a bristle mat and a plurality of wipes that is slidably receivable into the head of the brush;

FIG. 13 is an exploded front elevational view of an alternative version of the pre-loaded cartridge of FIG. 12;

FIG. 14 is a rear elevational view of the bristle mat that forms part of the cartridge depicted in FIG. 12;

FIG. 15 is a front view of an alternative version of the brush head of FIGS. 12 and 13 in which the head is provided with threads for attachment to the handle;

FIG. 16 is a top view of the brush depicted in FIG. 1 being selectively stored in a plastic case or cover;

FIG. 17 is a rear elevational view of the case or cover of FIG. 16 in an open condition;

FIG. 18 is a top plan view of another embodiment of the inventive brush in an open condition and depicting a non-replaceable pre-loaded bristle mat;

FIG. 19 is a bottom plan view of the brush of FIG. 18 in an open condition and depicting the bottom of the bristle mat with integral bristles shown as white dots within the plastic rib webbing;

FIG. 20 is a side view of an optional bristle to be used in the inventive brush;

FIG. 21 is a top view of a foam/sponge matrix to be placed over the bristle mat of the brush of FIGS. 18 and 19 prior to closing;

FIG. 22 is a top view of a pillow or cushion to be used instead of the foam/sponge matrix of FIG. 21, while FIG. 22A is a cross-section of a powder infused substrate;

FIG. 23 is a top plan view of an optional pillow cushion in which apertures are formed within preferably columns of any shape of mechanically, sonic, or adhesively sealed areas of FIG. 22;

FIG. 23A shows a cross-section of a pad formed of the pillow cushion of FIG. 23 illustrating outside fabric walls with the middle/interior containing hotmelt activated detergent or any medicinal, hair or scalp treatment chemical suspended in the hotmelt system actively release with warm water; or powder that migrates through the wipe/cloth.

FIGS. 24-24B show embodiments of brushes similar to the one in FIG. 12 with a built-in vibrating device;

FIGS. 25-25A show embodiments of brushes similar to the one in FIG. 13 with a built-in vibrating device;

FIGS. 26-26A show embodiments of brushes similar to the one in FIG. 1 with a built-in vibrating device;

FIGS. 27A-27I show an embodiment of the invention wherein the brush is a folding brush;

FIGS. 28A, 28B show another embodiment of a folding brush; and

FIG. 29A-E show an embodiment of a folding brush with a removable pillow filled with a powder.

### DETAILED DESCRIPTION OF THE INVENTION

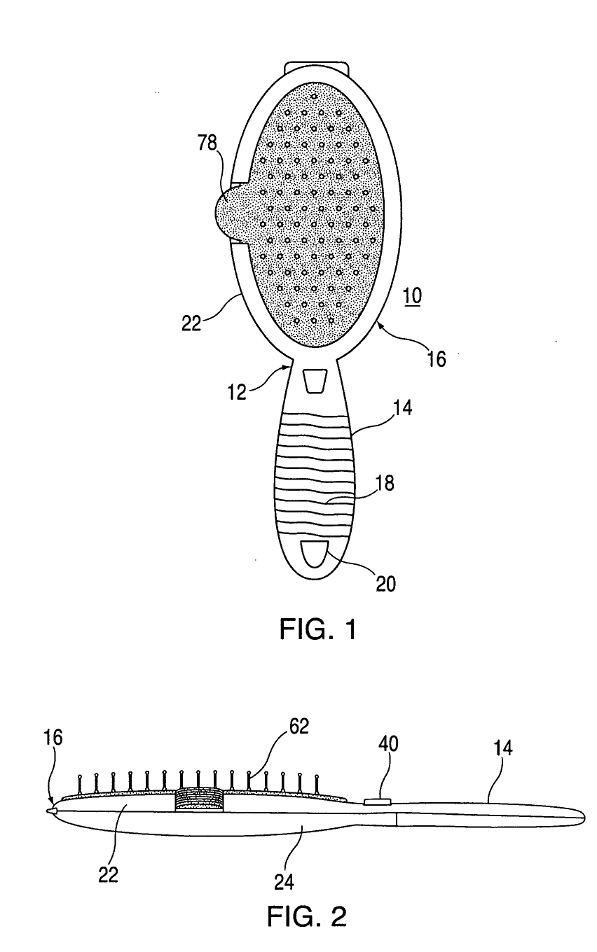

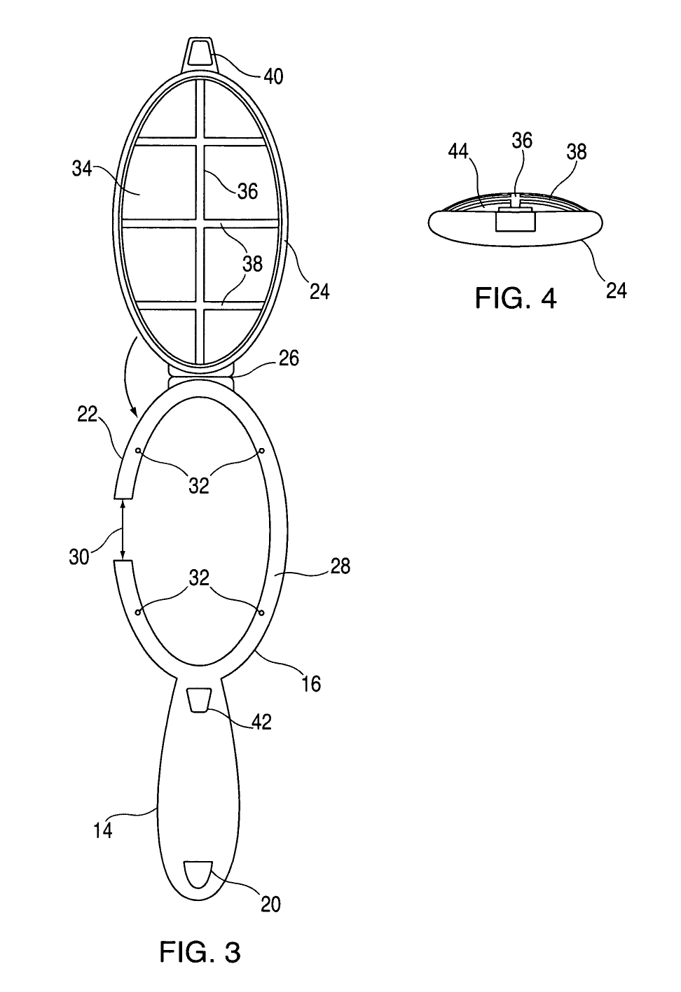

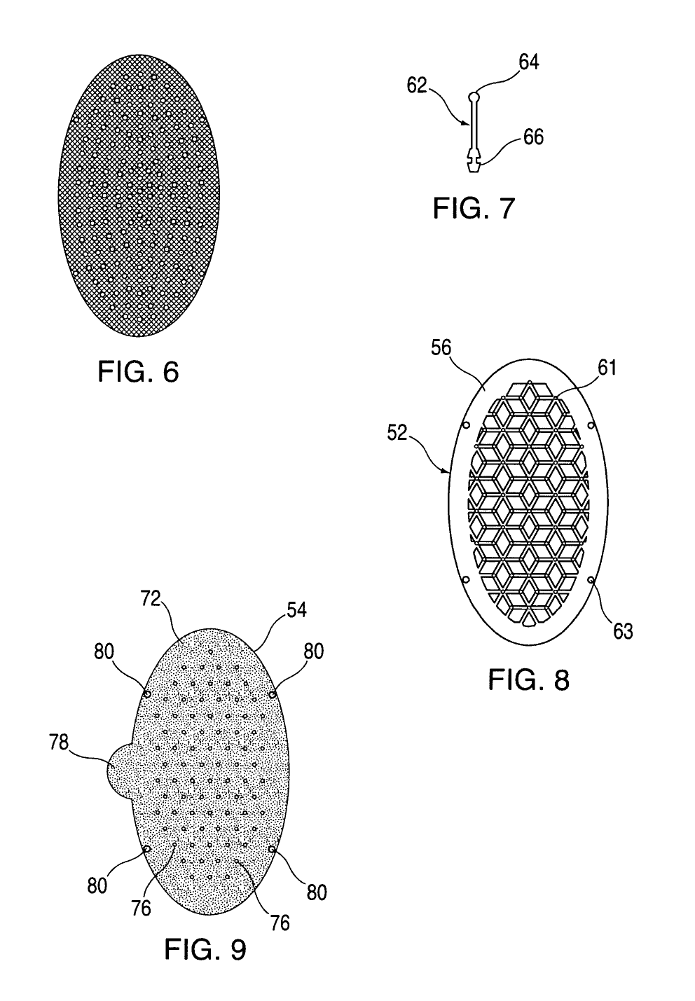

Referring first to FIGS. 1-9, a brush 10 constructed in accordance with this invention includes a handle 12 with a lower portion 14 and an upper portion 16. The lower portion is shaped and sized to fit in a person's hand so that the person can use the brush for brushing one's hair and perform other similar hygienic functions. The lower portion 14 may include grooves 18 or other similar features that provide the lower portion 14 with a non-slip surface. The lower portion may also be provided with various aesthetically pleasing elements. In addition, the lower portion 14 may also include a through hole 20 that allows the brush to be hung up on a hanger or nail.

The upper part 16 of the handle forms a frame consisting of two members 22, 24 having approximately the same size and shape. Member 22 is integrally formed with the lower part 14 and member 24 is hingedly connected to the lower part either by a living hinge 26 or by other similar hinges, such as a hinge formed with a pin and two or more sleeves attached to members 22, 24.

Member 22 is formed of a circumferential, planar wall 28 that is either continuous or, optionally, has a gap or opening 30. The wall 28 is made with several locating pins 32.

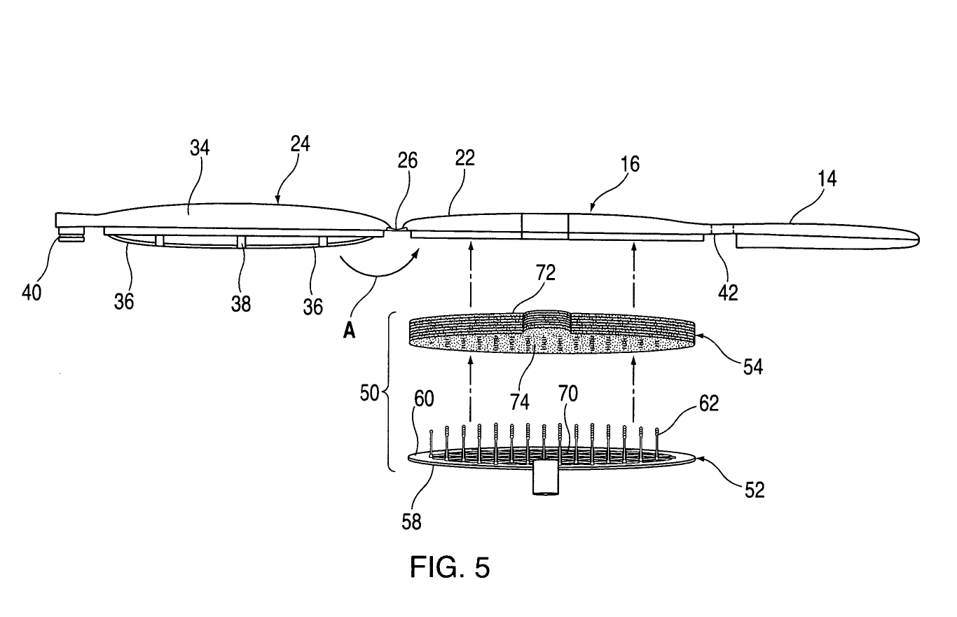

Member 24 preferably has a wall 34 that has a curved or bowed outer surface, as seen in FIGS. 4 and 5. Member 24 is also formed with a plurality of support elements 36, 38 attached to and extending between the edges of wall 34. At least one of these elements (element 36) extends along the vertical axis of the brush while the remaining elements 38 extend transversally. The supports are curved or bowed in an opposite direction to wall 34 as seen in FIGS. 4 and 5.

At the end opposite hinge 26, the member 24 is formed with a pushbutton or latch 40. The member 24 can be folded over member 22, as indicated in FIG. 5 by arrow A, and pushbutton 40 can selectively engage aperture 42 in the lower portion 14 to define a cavity 44 (see FIG. 4). The latch 40 can be disengaged by pressing thereon, thereby releasing the member 24 and allowing it to swing away from the member 22.

The brush 10 also includes a head 50 formed of a bristle assembly 52 and a pad 54. The bristle assembly 52 includes a base 56 with a bottom wall 58 and a circumferential frame 60. The bottom wall 58 is made with a plurality of holes 61. Additional positional holes 63 are made in the frame 60. Holes 63 have a diameter that is larger than the pins 32 on member 22.

Bristle assembly 52 also includes a plurality of extending bristles 62 shown in detail in FIG. 7. Each bristle has a rounded head 64 and a root 66 sized and shaped to snap into one of the holes 61. The base 56 of assembly 52 is generally lens shaped, and, as seen in FIG. 5, is formed with a plurality of flexible members or filaments 70 being affixed to bottom wall 58 and frame 60 and extending thereabove. The filaments 70 are made of a somewhat stiff material so that the whole base 56 is somewhat springy and resilient.

Pad 54 has a top surface 72, a bottom surface 74 and a plurality of holes 76. Holes 76 are arranged in the same pattern as the bristles 62 and the pad 54 has the same shape and size as the bristle assembly 52. Therefore, the pad 54 can be placed on top of the bristle assembly 52 with the bristles passing through the pad and protruding above holes 76. On one side, pad 54 has a tab 78 matching the position of opening 30 of member 22 of bristle assembly 63. The pad also has a plurality of peripheral holes 80 matching the positioning holes 63.

In one embodiment, the pad 54 is made of a resilient shape-retaining material such as a sponge or foam. Optionally. the pad 54 is covered with a sheet made of a waterproof material to protect the sponge or foam and to make it easier to clean.

In another embodiment, the pad 54 consists of a single or a plurality of superimposed identical sheets made of woven or non-woven cloth, or a non-woven matrix with powder situated between the layers, that can be removed from the bristles.

The brush is assembled as follows. First, the brush head 50 is positioned under member 22, as shown in FIG. 5. The brush head 50 is larger than the opening in member 22, and the pins 32 are inserted through holes 63 and 80, thereby insuring that the brush head is properly placed with respect to members 22, 24. The member 24 is then swung clockwise in the direction of arrow A in FIG. 5, thereby trapping the brush head 50 within cavity 44 (see FIG. 4). The support members 36, 38 push the brush head 50 upward with the bristles 62 and at least a portion of the pad 54 being pushed outwardly, as seen in FIG. 2.

As described above, the bristle assembly 52 forms a bristle mat. This base may be made of various man-made materials such as polypropylene, polyurethane, vinyl, ABS, styrene, rubber and so on. Its lens-shaped body imposes an outward or convex shape on pad 54 as shown in FIG. 2.

Once assembled, the brush is ready to be used for brushing the hair of a person, or the fur of an animal, or performing other hygienic functions as desired. For various functions requiring the application of water, an aqueous solution or other liquids, the head is provided with a pad 54 that is made of a sponge or foam so that it can retain some of the liquids.

For dry applications, the pad 54 is formed of a plurality of superimposed separable sheets. As the brush 10 is being used, hair, fur and other matter can get entangled or trapped between the bristles 62. The brush can be cleaned by holding the tab 78 of the topmost sheet and then removing this sheet by pulling it upwards over the bristles 62. This action causes extraneous material between the bristles 62 to be removed without separating members 22 and 24. The next sheet of pad 54 is clean and the brush can then be reused.

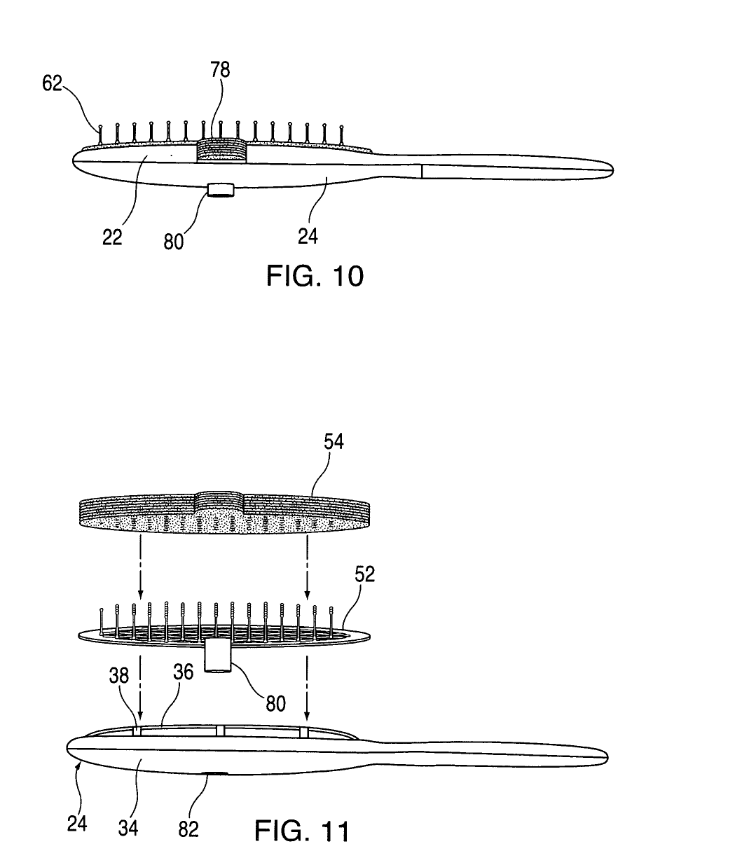

In the embodiment shown in FIGS. 1-9, the head 50 is captured between the members 22, 24. In an alternate embodiment shown in FIGS. 10 and 11, a more positive lock is provided for maintaining and supporting the head 50 in place. For this purpose, bristle assembly 52 is provided with a downwardly extending tongue 80, as shown in FIG. 11. The tongue passes through and is captured by an aperture 82 in the wall 34 of member 24 to lock the head 50 in place. The resulting brush 10A is shown in FIG. 10. The head is released by pushing the tongue 80 out of aperture 82.

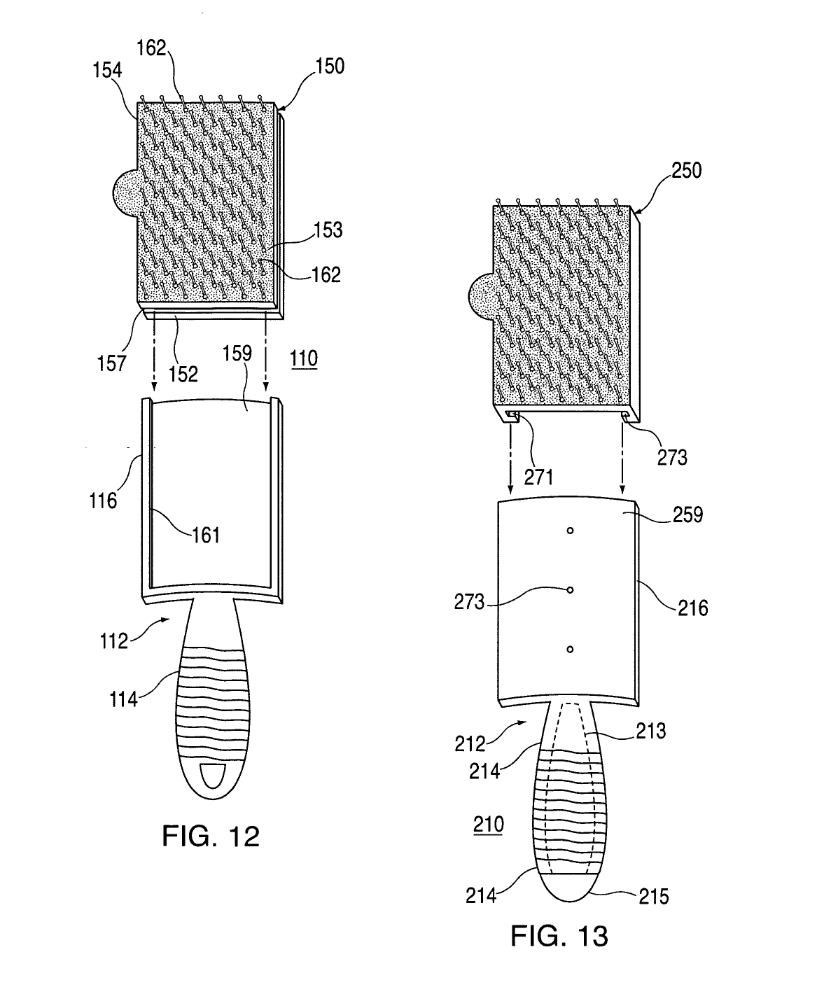

FIG. 12 shows another embodiment of the invention. In this embodiment, a brush 110 is shown with a handle 112 with a lower part 114 and an upper part 116. The upper part 116 is sized and shaped to receive head 150 with a base 152 and a pad 154. Head 150 forms a preloaded refill cartridge with a plurality of wiping sheets 153.

The base 152 is made of a plastic material and includes the bristles 162 extending through sheets 153. The base 152 is generally rectangular and has a circumferential groove 157 along is sides.

The upper part 116 of handle 112 includes a wall 159 that is generally curved outwardly to provide the pad 154 with a predetermined shape. A peripheral wall 161 is provided around the wall 159. The head 150 and handle 112 cooperate so that the head can slide longitudinally into the upper part 116 with the wall 161 being received in the groove 157.

FIG. 13 shows a brush 210 similar to brush 110. However, in this embodiment, the head 250 is formed with downwardly extending slots or channels 271, 273 that receive the upper part 216 of handle 212. In this embodiment, the handle 212 is also used as a reservoir for a liquid. The reservoir 213 is stored in the lower part 214 and can be accessed through a screw-on cap 215. The wall 259 of upper part 216 is formed with holes 273 through which liquid from the reservoir can be ejected into the head when a standard liquid pumping member (not shown) is activated. Again, the wall 259 is curved to shape the head 250.

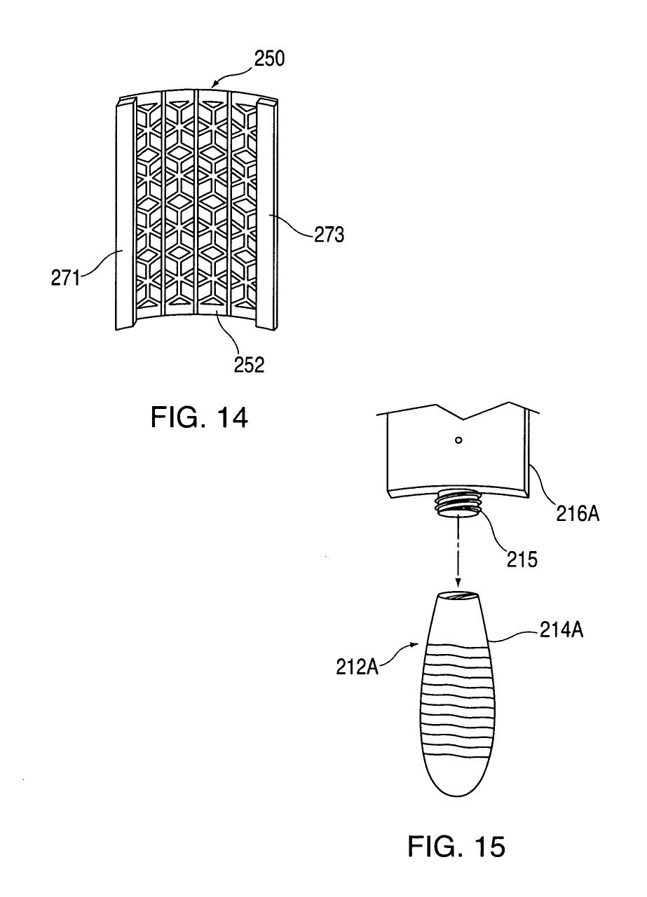

As shown in FIG. 14, preferably, the head 250 is formed with a base 252 made of a plurality of plastic elements similar to the base 52 discussed above. The channels 271, 273 are formed integrally on the base 252.

In an alternate embodiment shown in FIG. 15, the upper and lower parts 214A, 216A of handle 212A are made separately and are joining together using a threaded connection 215.

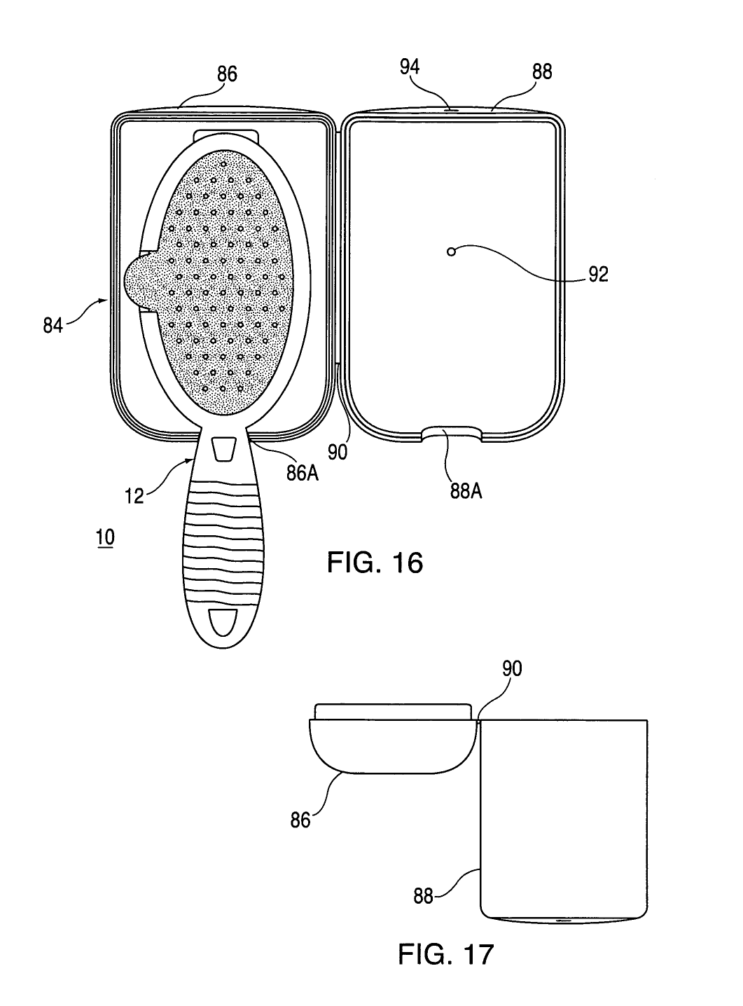

As discussed above, the brushes shown in the drawings can be used for dry or wet applications. In the case of wet applications, drying out of the pad 52 may be a concern. In order to overcome this problem, the brush 10 (or any of the other brushes described herein) is stored in a sealed container. In a preferred embodiment, a container 84 shown in FIGS. 16 and 17 is provided that has two sections 86, 88 joined by a hinge 90 that may be a living hinge or any other hinged mechanism. The two sections are formed with cutouts 86A, 88A that conform to the cross-sectional shape of the handle 12. The two sections can be closed around the handle 12, thereby creating a seal for the brush to prevent liquid evacuation. One or more apertures 92, 94 may be provided in the container 84 through which liquid may be introduced into the container 84.

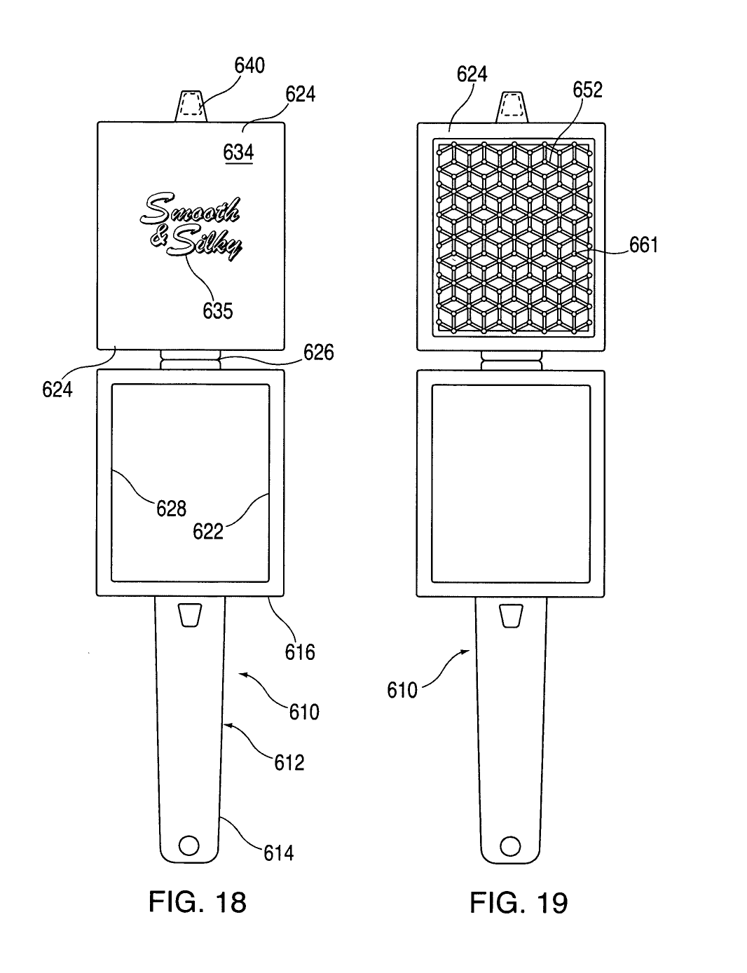

In the embodiments described above, the whole head 50 is replaceable. Of course, the brush can be constructed and arranged so that the head is either fixed (e.g., non-replaceable) or partially replaceable. In the embodiment of FIGS. 18 and 19, a brush 610 is shown with a handle 612 having a lower portion 614 and an upper portion 616. The upper portion 616 includes two members 622, 624 joined by hinge 626. Member 622 is joined to lower portion 614 and is formed with a peripheral wall 628. The member 624 has a wall with an outer surface 634. Optionally, text may be provided on surface 634, as at 635.

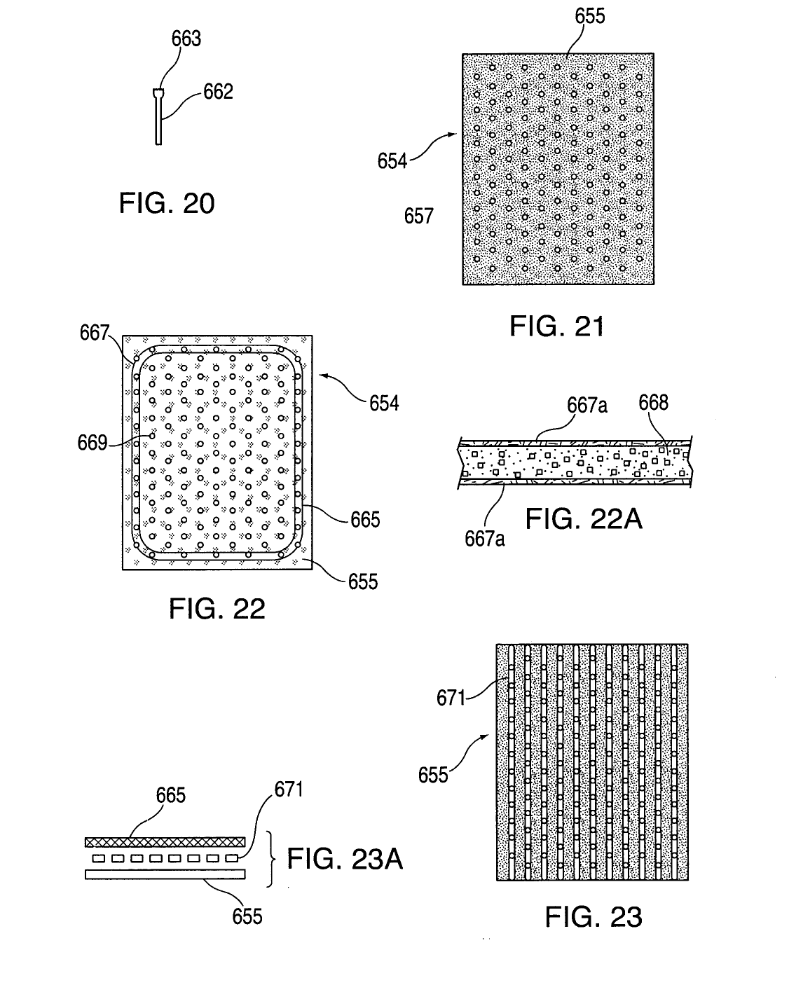

As seen in FIG. 19, on the opposite side of surface 634, the member 624 is formed integrally with a base 652 made of elastomeric flexing elements with holes 661. The base 652 holds a plurality of bristles. In one embodiment, the bristles can have rounded heads, as shown in FIG. 7. In another embodiment shown in FIG. 20, bristles 662 terminate in a plurality of fingers 663. These fingers provide for massaging the skin or the scalp. A pad 54 (not shown) is then mounted on the bristles and is captured between the parts 622, 624 as before. The parts can be permanently locked together, thereby making the head non-replaceable. Alternatively, the parts can selectively be opened by activating button 640, thereby allowing a user to change the pad.

The pad used in the brush 610 could have the same structure as described above (e.g., either a soft foam or sponge, or a plurality of individually releasable sheets). In an alternate embodiment shown in FIGS. 21, 22, 23 and 23A, a two-layered pad is used. This pad 654 can be used either with the embodiment of FIGS. 18-19 or any of the previous embodiments. The pad 654 includes a foam layer 655 made with a plurality of apertures 657 matching the locations of bristles 662. In one embodiment (FIG. 21), the foam layer 655 alone forms pad 654. The layer 655 may have a thickness that is larger or smaller then the length of bristles 662. If the layer 655 is thicker then the length of bristles 662, then, when the brush is not in use, the bristles are completely imbedded in the layer 655. When the brush is used, the foam is compressed, at least partially revealing the bristles 662. Then, when the brush is removed, the pad resumes its normal shape, thereby enveloping the bristles 662 and causing any hairs, fur or other matter to be automatically removed from the space between the bristles. This feature is addressed more fully in co-pending application Ser. No. 11/480,149 identified above. The foam layer 655 could be a dry layer, or could be impregnated with various liquids such as soap, shampoo, conditioner, styling gel and/or a medicament. Any or all of these materials may be premoistened or may be water activated, or embedded with powder.

In another embodiment (FIG. 22), the pad 654 includes a thinner layer of foam 655 and a layer of a pillow or cushion 665. The cushion 665 consists of two sheets (such as sheet 667) sealed to each around the edges by ultrasonic welding, an adhesive and other similar means. Alternatively, as shown in FIG. 22A, sheets or substrates 667 are sealed to each other by a mixture 668 of heat activated adhesive powder/particles and hair treatment powder/particles. As shown, a desired material is disposed inside the cushion that is either in a dry form, in which case it must be activated by heat or water, or in a liquid form, or in a dry powder from with a particle size of 10 microns or more to promote migration through the powder layers of foam or non-woven material.

Turning again to FIG. 22, the sheet 667 is made with perforations (not shown) or made of a material that is permeable or otherwise promotes the migration of the contents of the cushion so that these contents can be released while the brush is used.

Optionally, sheet 667 is provided with a plurality of ink dots 669 distributed in a predetermined pattern. Ink dots are created using a printing process. Heat is applied to cure and expand the ink creating a multi-dimensional dot. These dots provide additional hair/fur grooming benefits, including a combing action and improved loose hair collection.

Pillow 665 is attached to the foam layer 655 by any well known means. For example, as shown in FIG. 23, one side of the pillow or cushion 665 is provided with several strips 671 of hot melt adhesive material. These strips may be used to join either a cushion 665 to a foam layer 655, as shown in FIG. 23A, or alternatively, several cushions 665 may be joined together in this manner to form a pad 654. Optionally the cushion 665 can contain powder treatments between the seals. This powder can be dry, or can be water activated. Some examples of dry powders include talc that acts as an oil absorbing substance to an oily scalp or hair. The talc is released through the porous materials used in forming the outside walls/coverings of the pillow. The talc migrates through said porous wall and this action is aided by vibration created by a motor in the handle of the brush, as described in more detail below.

The brushes described herein are used for cleaning and personal hygiene as well and may include additional features and components that can be used to providing various types of treatment and promoting well being. For example, it is well known that massaging the skin and scalp has various benefits and therefore, the brushes described below incorporate elements that provide selectively vibration functions.

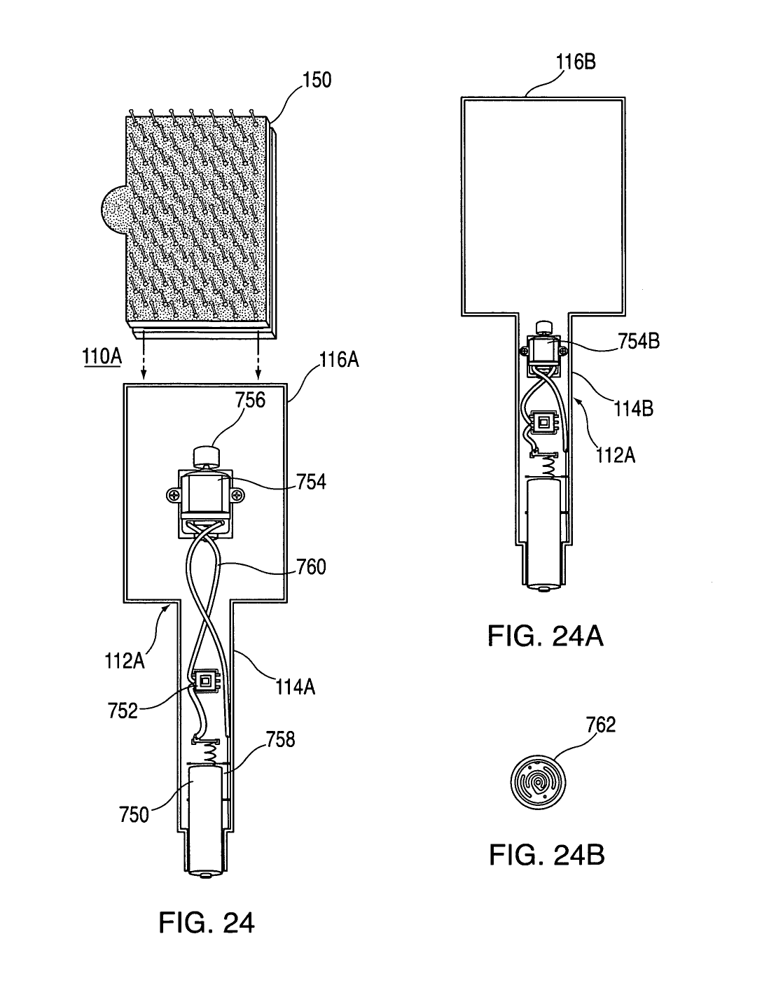

In FIG. 24, a brush 110A is shown that is similar to the brush 110 of FIG. 12, but has a built-in vibrating device. Brush 110A includes a handle 112A with a bottom portion 114A and a top portion 116A. The top portion 116A is constructed and arranged to receive the fixed or replaceable brush head 150 having bristles and a pad. The bottom portion 114A has a generally cylindrical shape and it houses a battery 750, an activating switch 752 and a motor 754 with a rotating axis for turning a counterweight 756. The counterweight 756 is off-balance so that its rotation causes the brush to vibrate. When the switch 752 is closed, current from battery 750 flows through conventional wires 760 to activate the motor 754. In the embodiment of FIG. 24, the motor 754 is disposed in the top portion 116A. The battery 750 is disposed in a compartment 758 formed in bottom portion 114A and closed by a cap 762 shown in FIG. 24B.

FIG. 24A shows an embodiment similar to the one in FIG. 24, but with the motor 754B being disposed in the lower portion 114B rather then the upper portion 116B of the brush handle.

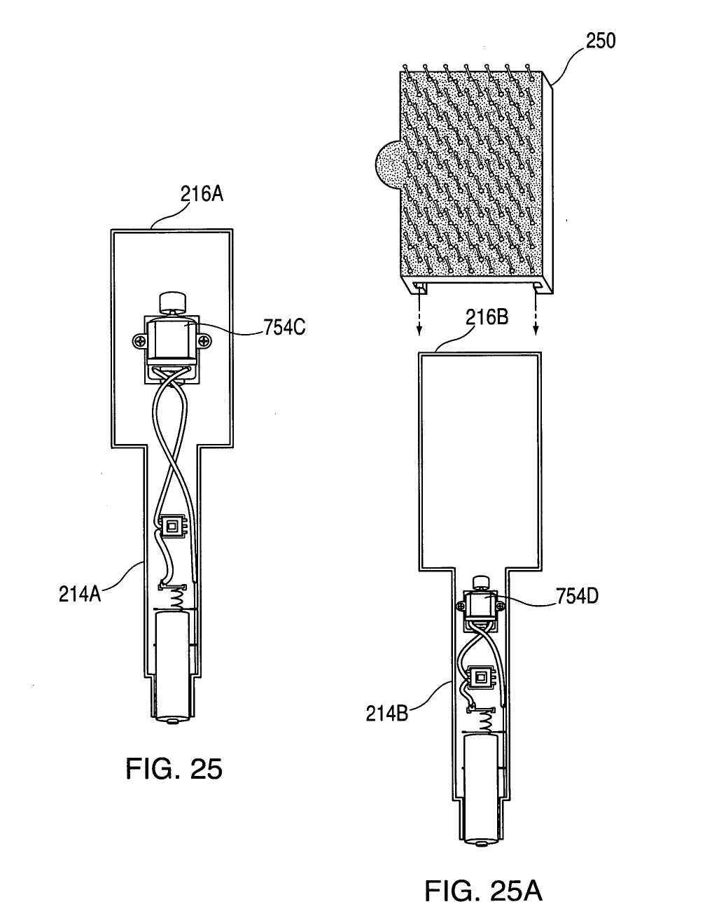

FIGS. 25 and 25A show a brush similar to the brush of FIG. 13. In FIG. 25, the brush is provided with a motor 754C in the upper portion 216A of the handle. In FIG. 25A, the brush is provided with motor 754D in lower portion 214B.

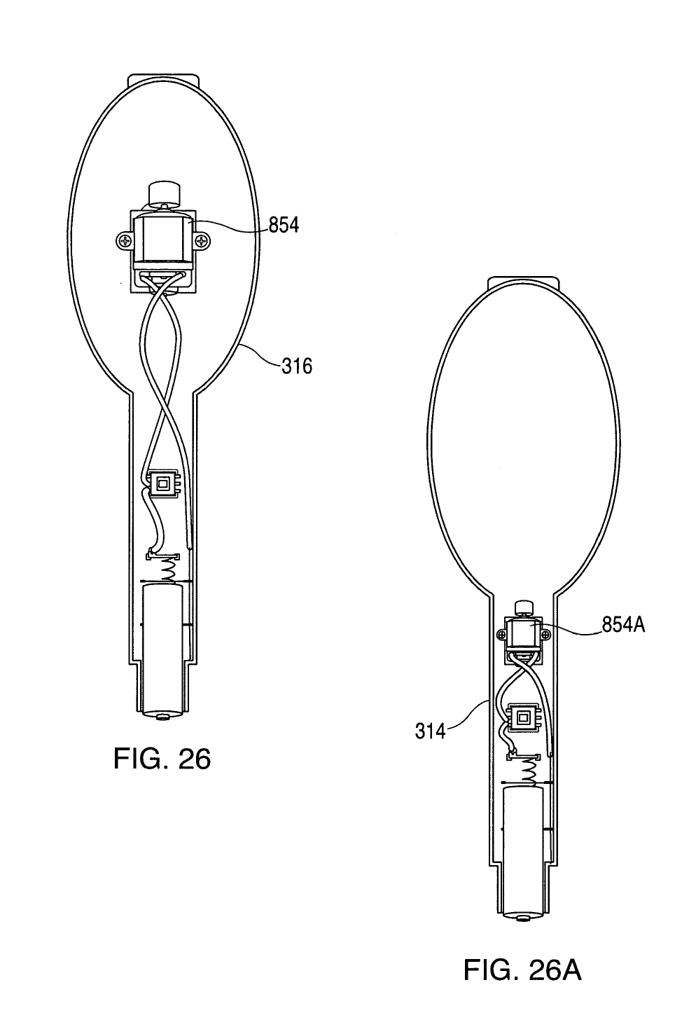

FIGS. 26 and 26A show a brush similar to the brush of FIG. 13. In FIG. 26, the brush is provided with a motor 854 in the upper portion 316 of the handle. In FIG. 26A, the brush is provided with motor 854A in lower portion 314 of the handle.

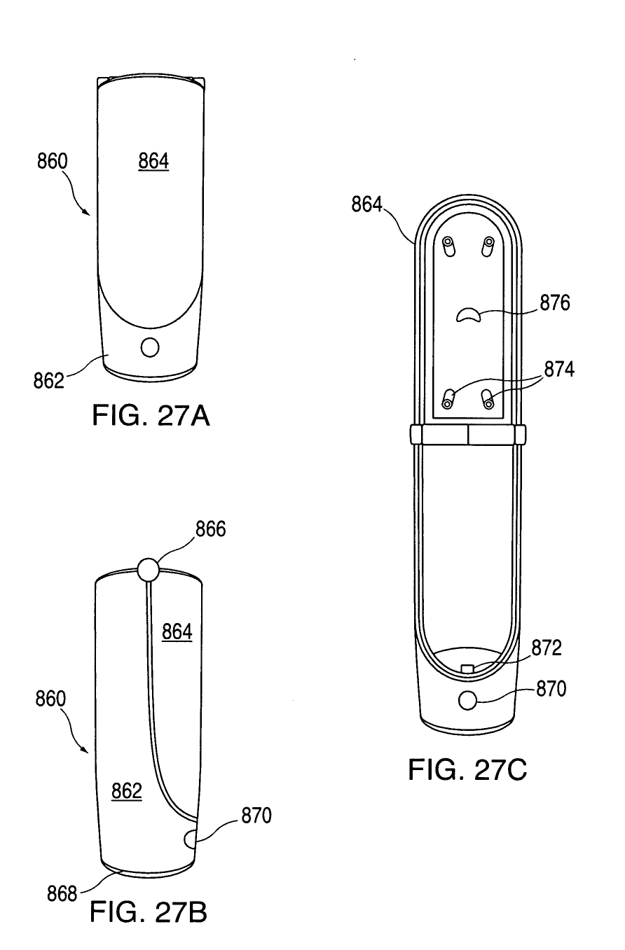

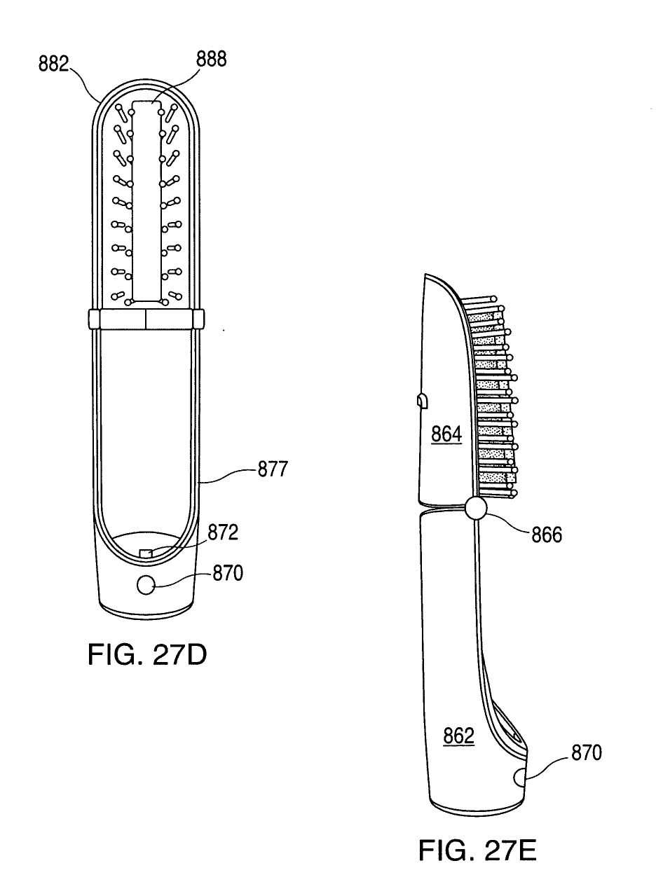

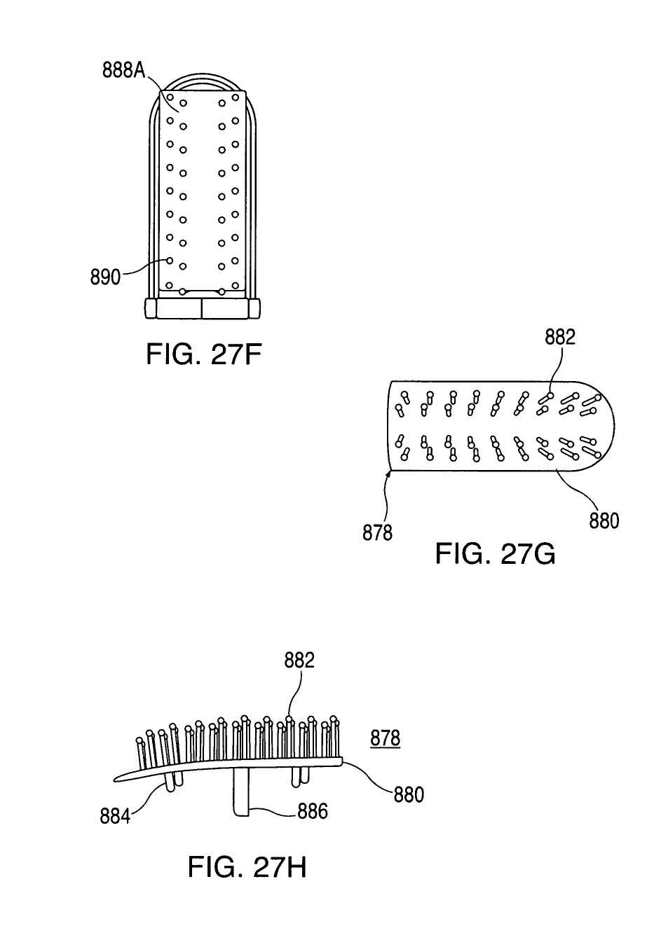

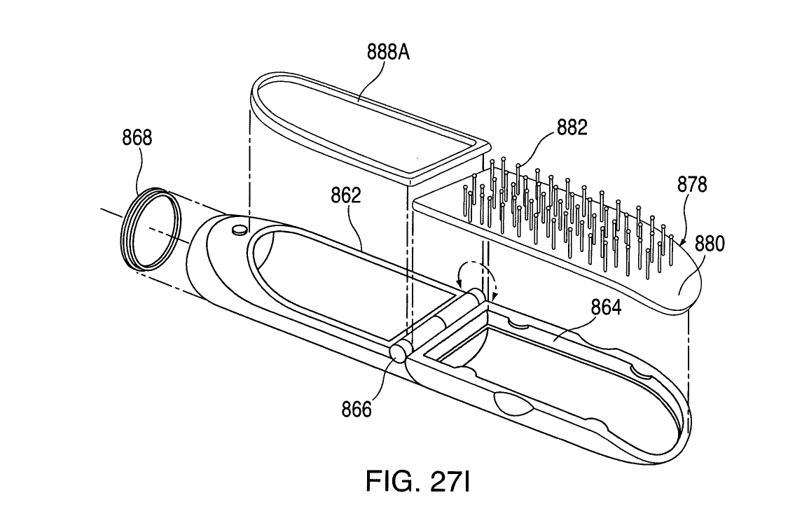

FIGS. 27A-27I show a folding brush 860, formed of two sections 862, 864 joined by a hinge 866. Section 862 forms the handle for the brush and may be used to store a liquid container and/or a motor as described in the earlier embodiments. For this purpose, the brush is provided with a cap 868 that can be either screwed or snapped to the section 862 to provide access to an interior cavity within the handle. The section 862 further includes a release button 870. The two sections 862, 864 are in a closed position as shown in FIGS. 27A and 27B and are interlocked by a locking mechanism 872. When the release button 870 is activated, it releases the locking mechanism 872 and allows the two sections 862, 864 to pivot to an open position. The hinge 866 may include a spring(not shown) that biases the two sections into the open position. As a result, when the release button 870 is activated, the brush snaps into its open position.

As shown in FIG. 27C, section 864 forms a shell or housing with a plurality of hollow posts or plugs 874 and at least one opening 876.

The brush 860 further includes a bristle mat 878 (FIGS. 27G and 27H) including a base 880. A plurality of bristles 882 are attached to the base 880 in a conventional manner. On the side opposite bristles 882, the base 880 has a plurality of rods 884 sized and shaped to snap-fit or form an interference fit with the posts 874 of section 864. Moreover, the mat 878 further includes a slightly larger post 886 sized and shaped to fit into, and to form an interference fit, with the opening 876 of section 864. Thus, when the mat 878 is fit and pressed on along base 880, the rods 884, posts 874, post 876 and opening 876 cooperate to mount the bristle mat 878 on the section 864. The bristle mat 878 can be released by pushing on post 886.

In one embodiment, the bristles 882 are arranged longitudinally in two or more rows defining an elongated space therebetween. An elongated matrix 888 may disposed in the space between the bristles as shown in FIG. 27D. In an alternate embodiment, a matrix 888A (FIG. 27F) is provided that has substantially the same dimensions as mat 878 (FIG. 27I). In this case, the matrix 888A is formed with holes 890. The bristles pass through the holes 890 as shown in FIGS. 27E and 27F.

The brush 860 can be closed as shown in FIGS. 27A and 27B for storing in a purse, pocket book, etc., and can be opened for use. If liquid is stored in the handle, then the brush sections 862, 864 can be formed with a peripheral lip around their rim as at 877 in FIG. 27D to provide a watertight seal. In this manner, any liquid that may spill onto the bristle mat 878 contained within the brush housing will not leak out.

The matrix 888 or 888A can be affixed permanently to the base 880 of mat 878 using an adhesive or other known means, or may be removable at will. Preferably, the matrix is thicker then the height of the bristles so that it can engage the skin or scalp for applying treatment and for removing extraneous matter from the bristles, as in the previous embodiments.

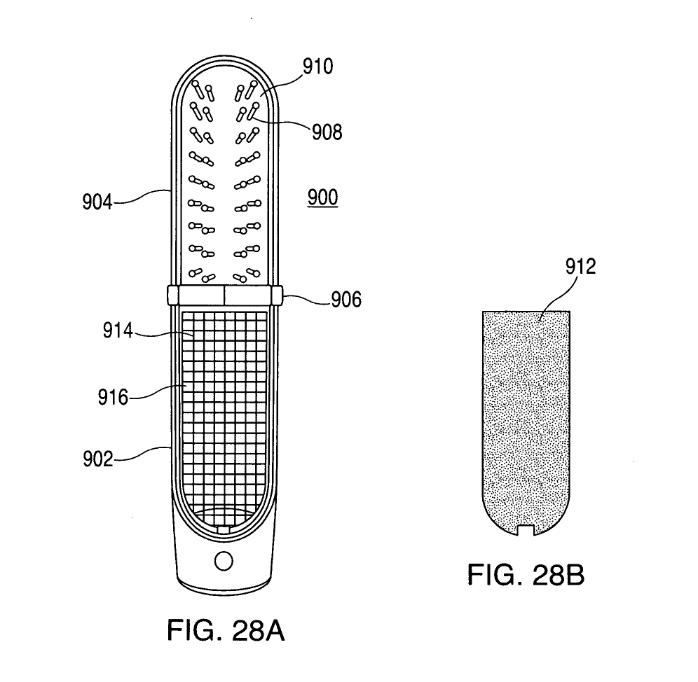

FIGS. 28A and 28B show a different construction for a closeable brush. In these figures, brush 900 has a two-piece housing formed of sections 902, 904 joined by a hinge 906. Section 904 holds a plurality of bristles attached to a base 910. A matrix 912 is sized and shaped to fit over the bristles 908. The matrix 912 can be treated with various medical and/or hygienical compositions. Importantly, the brush further includes a mesh or grid 914 shaped and sized to fit over the brushes. Preferably, grid 914 is made of plastic and is pivotably supported by the hinge 906. The grid can be pivoted into an open position shown in FIG. 28A. With the grid 914 in this position, the matrix 912 can be placed over the bristles 908. The grid can then be closed to form a cage for the matrix 912 with the bristles protruding through openings 916 in the grid. The grid 912 can be sized and shaped to push the matrix 912 into place to maintain it in a slightly compressed state. In one embodiment, the matrix 912 is made from a single piece.

In an alternate embodiment, the matrix 912 is made of several plies or layers of a soft, resilient material. Each layer includes a release sheet which allows the top layer of the matrix to be removed. Brush 900 is then assembled by placing the matrix 912 over the bristles and swinging the grid 914 over the matrix 912 to hold it in place. After one or more uses, the grid 914 is opened, the top layer of the matrix 912 is removed and discarded and the grid 914 is reclosed.

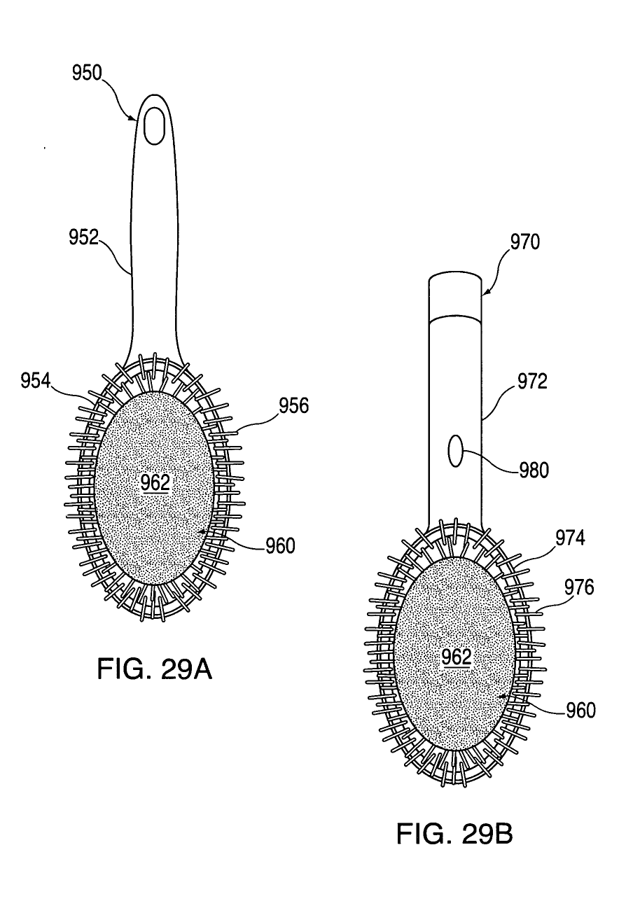

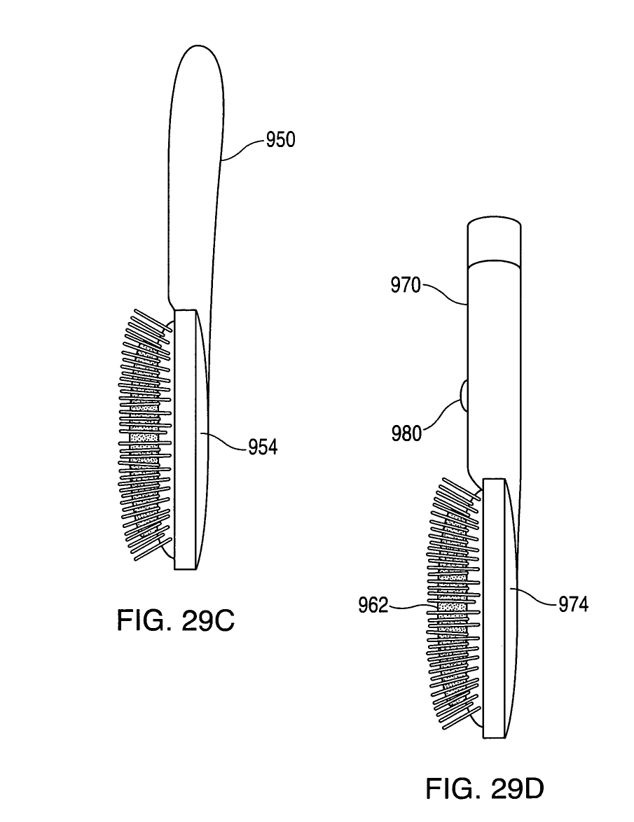

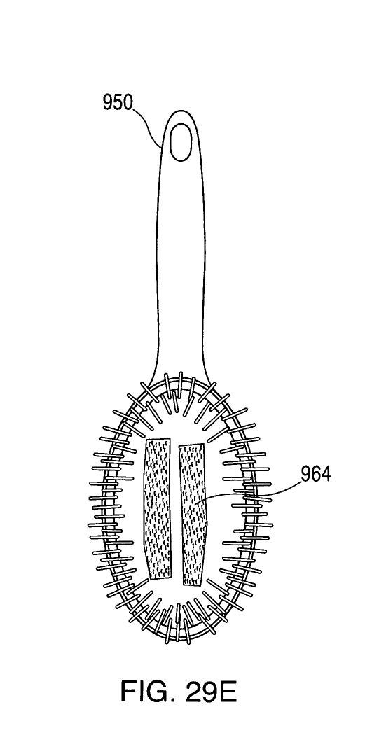

Two other embodiments of the invention are shown in FIGS. 29A-29E. Brushes 950 and 970 illustrated herein have a very similar construction. The basic difference between them is that brush 950 has a regular handle, while brush 970 includes a vibrating motor in the handle or the head and a switch is incorporated into the handle to operate the vibrating motor.

More particularly, brush 950 (see FIGS. 29A and 29C) includes a handle 952 and a head 954. Two or more rows of bristles 956 are arranged peripherally along head 954, thereby leaving a central region open. A pillow 960 is disposed between the bristles 956 as shown.

Similarly, brush 970 (see FIGS. 29B and 29D) includes a handle 972 and a head 974. Two or more rows of bristles 976 are arranged peripherally on head 974, thereby leaving a central region open. A pillow 960 is disposed in the central region between the bristles 976 as shown. As discussed above, brush 970 includes a vibrating motor (not shown) activated by a switch 980 on the handle.

The pillow 960 is secured to the head 954, 974 by adhesive strips 964, as shown in FIG. 29E. Alternatively, the strips 964 may support the hook members of a hook-and-loop type securing tape, the loop members being provided by, or being affixed to, the back of the pillow 960; pillow 960 may be made of a fuzzy material for this purpose.

The pillow 960 forms an enclosure for a powder that may be a water absorbent material, an oil absorbent material, a disinfectant, etc. The front face 962 of the pillow is made of a non-woven fabric or similar material that has interstices of predetermined sizes commensurate with the dimensions of the powder grains. The face 962 may also absorb water or oil and therefore provides a cleaning action as the brush is applied. During use, the powder exits or migrates through the front face 962 to be deposited on skin, hair, scalp, etc. his migration is assisted in brush 970 by the vibrating motor.

Obviously numerous modifications may be made to the invention without departing from its scope as defined in the appended claims.

I claim:

1. A brush comprising:
a handle with a lower portion and an upper portion forming a cavity and a closure member for selectively closing said cavity, said closure member including a window in communication with said cavity; and
a head including a base supporting a plurality of bristles, said head being sized and shaped to fit into said cavity with said bristles extending outwardly through said window for use.

2. The brush of claim 1, further comprising a pad including a matrix disposed between said bristles and arranged and constructed to compress when said brush is used on any of skin, scalp, hair or fur and then decompress when said brush is removed, thereby delivering medicaments removing materials deposited on the bristles.

3. The brush of claim 2, wherein said pad includes a plurality of removable sheets covering said matrix.

4. The brush of claim 1 wherein said head is selectively removable from said cavity.

6. The brush of claim 1, wherein said base includes a plurality of flexible members for allowing said base to flex in a direction parallel to said bristles.

7. The brush of claim 6, wherein said base is lens-shaped.

8. The brush of claim 1, wherein said upper portion includes support members arranged and constructed to support said head within said cavity.

9. The brush of claim 8, wherein said support members have a predetermined curvature selected to impart a preselected shape to said head.

10. The brush of claim 1, wherein said base consists of a peripheral wall and a plurality of flexible elements interconnected between said peripheral wall and having holes, each bristle optionally being engaged by one of said holes.

11. The brush of claim 1, further comprising a locking member attached to said base and arranged to removably lock said base to said handle.

12. The brush of claim 1, further comprising a vibrating device that provides vibration for said brush.

13. A brush comprising:
a handle including an elongated lower portion and an upper portion including a first member formed of a peripheral wall defining a window and a second member hingedly connected to said first member and having a first position in which said second member is pivoted away from said first member and a second position in which said first and second members are disposed in an opposed relationship to define a cavity; and
a head having a base sized and shaped to fit into said cavity, said first and second member cooperating to secure said base within said cavity, said head further including a plurality of bristles attached to said base and being oriented to extend outwardly through said window as said head is disposed in said cavity said bristles extending preferably through said holes.

14. The brush of claim 13, wherein said second member has a perimeter cooperating with said peripheral wall to capture said base therebetween.

15. The brush of claim 14, wherein said bristles extend through said window.

16. The brush of claim 15, wherein said second member includes a plurality of support elements made of a resilient material, said support elements being positioned to bias said head against said first member.

17. The brush of claim 16, wherein said support elements are shaped and sized to cause said head to bulge out of said window at a predetermined curvature.

18. The brush of claim 21, further comprising a pad with a plurality of holes for receiving said bristles, said pad being made of one of foam, a sponge or both.

19. The brush of claim 16, wherein said lower portion has a tubular body housing a reservoir for holding a liquid, said brush further including dispensing means for dispensing said liquid.

20. A brush comprising:
a replaceable head including a base holding a plurality of bristles and a pad disposed on said bristles; and
a handle with an upper portion sized and shaped to receive said head and a lower portion sized and shaped to fit in a person's hand;
said upper portion forming a window with said bristles extending through said window and said bristles being imbedded in said pad and arranged to cooperate with said pad to allow said pad to automatically remove materials deposited between said bristles during use.

21. The brush of claim 20, wherein said upper portion has an elongated body and said head includes channels for receiving said elongated rectangular body as said head is mounted on said handle.

22. The brush of claim 20, wherein said upper portion has a preselected curvature and said head is flexible and assumes said curvature as said head is mounted on said handle.

23. The brush of claim 20, further comprising a vibrating device including a motor with a counterweight, said motor being disposed in one of said upper and said lower portions.
